(19) United States
(12) Patent Application Publication
(10) Pub. No.: US 2009/0063570 A1
(43) Pub. Date: Mar. 5, 2009

(54) METHOD AND SYSTEM FOR COUNTING FILES AND DIRECTORIES IN A NEW-TECHNOLOGY-FILE-SYSTEM (NTFS) VOLUME THAT ARE RELEVANT TO A COMPUTERIZED PROCESS

(76) Inventors: Anthony Lynn Nichols, Eric, CO (US); Jurijs Girtakovskis, Broomfield, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/846,204

(22) Filed: Aug. 28, 2007

(51) Int. Cl. G06F 12/00; G06F 11/00

(52) U.S. Cl. 707/200; 726/22; 707/E17.001

(57) ABSTRACT

A method and system for counting files and directories in a New-Technology-File-System (NTFS) volume that are relevant to a computerized process is described. One illustrative embodiment counts bits corresponding to used MFT entries in a Master File Table (MFT) bitmap associated with the NTFS volume to obtain a first count; counts one or more files or directories in the NTFS volume that are not relevant to the computerized process to obtain a second count; subtracts the second count from the first count to obtain a count of files and directories in the NTFS volume that are relevant to the computerized process; and displays a progress indicator that indicates, with the passage of time, what proportion of the files and directories included in the count of files and directories in the NTFS volume that are relevant to the computerized process has been processed by the computerized process.

### FIELD OF THE INVENTION

The present invention relates generally to computer file systems. In particular, but not by way of limitation, the present invention relates to methods and systems for counting files and directories in a New-Technology-File-System (NTFS) volume that are relevant to a computerized process.

### BACKGROUND OF THE INVENTION

A wide variety of computer software applications have a need to determine how many files and directories stored on a New-Technology-File-System (NTFS) volume are relevant to that particular application. For example, a program may be configured to process a high percentage of the files and/or directories on the NTFS volume for some purpose. In such applications, counting the relevant files and/or directories on the volume facilitates providing a progress indicator as the files and/or directories are processed. Such a tally of relevant files and directories can also be useful in allocating memory to the application, in performing diagnostics, or in providing volume statistics.

Conventional software applications count files and directories on an NTFS volume by ascertaining the existence of each file or directory one at a time using Application Programming Interfaces (APIs) of the operating system. Using this approach, it can easily take an application over two minutes to count substantially all of the files and directories on an NTFS volume. Such a delay is unacceptable in many cases.

It is thus apparent that there is a need in the art for an improved method and system for counting files and directories in a NTFS volume that are relevant to a computerized process.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for counting files and directories in a New-Technology-File-System (NTFS) volume that are relevant to a computerized process. One illustrative embodiment is a method for counting files and directories in a New-Technology-File-System (NTFS) volume that are relevant to a computerized process, the method comprising counting bits corresponding to used MFT entries in a Master File Table (MFT) bitmap associated with the NTFS volume to obtain a first count, each used MFT entry corresponding to one of a file and a directory in the NTFS volume; counting one or more files or directories in the NTFS volume that are not relevant to the computerized process to obtain a second count; subtracting the second count from the first count to obtain a count of files and directories in the NTFS volume that are relevant to the computerized process; and displaying a progress indicator that indicates, with the passage of time, what proportion of the files and directories included in the count of files and directories in the NTFS volume that are relevant to the computerized process has been processed by the computerized process.

Another illustrative embodiment is a method for counting files and directories in a NTFS volume that are relevant to a computerized process, the method comprising counting bits corresponding to used MFT entries in a Master File Table (MFT) bitmap associated with the NTFS volume to obtain a first count, each used MFT entry corresponding to one of a file and a directory in the NTFS volume; counting one or more files or directories in the NTFS volume that are not relevant to the computerized process to obtain a second count; subtracting the second count from the first count to obtain a count of files and directories in the NTFS volume that are relevant to the computerized process; and using the count of files and directories in the NTFS volume that are relevant to the computerized process in determining memory requirements for the computerized process.

Other illustrative embodiments include digital computer systems for carrying out the methods of the invention and computer-readable storage media containing program instructions implementing the methods of the invention.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1A is a functional block diagram of a digital computer system in accordance with an illustrative embodiment of the invention;

FIG. 1B is a functional block diagram of a digital computer system in accordance with another illustrative embodiment of the invention;

FIG. 2 is a diagram of a Master File Table (MFT) and a lookup table for rapidly counting files and directories in a New-Technology-File-System (NTFS) volume in accordance with an illustrative embodiment of the invention;

FIG. 3 is an illustration of a progress indicator in accordance with an illustrative embodiment of the invention;

FIG. 4 is a flowchart of a method for counting files and directories in a NTFS volume that are relevant to a computerized process in accordance with an illustrative embodiment of the invention;

FIG. 5 is a flowchart of a method for counting files and directories in a NTFS volume that are relevant to a computerized process in accordance with another illustrative embodiment of the invention;

FIG. 6 is a flowchart of a method for rapidly counting substantially all of the files and directories in a NTFS volume in accordance with an illustrative embodiment of the invention; and

FIG. 7 is a flowchart of a method for counting files that are not relevant to a computerized process in accordance with another illustrative embodiment of the invention.

### DETAILED DESCRIPTION

In an illustrative embodiment of the invention, substantially all of the files and directories in a New-Technology-File-System (NTFS) volume are rapidly counted by counting the bits corresponding to used Master File Table (MFT) entries in the MFT bitmap associated with the NTFS volume. A count of files and directories that are not relevant to a particular computerized process is then subtracted from this total to yield the number of files and directories in the NTFS volume that are relevant to the computerized process. The count of relevant files and directories may be used for a wide variety of purposes. Examples include, without limitation, the displaying of a progress bar that shows, with the passage of time, the proportion of files and directories in the NTFS volume that has been processed by the computerized process and the determination of memory requirements for the computerized process. Those skilled in the applicable art will recognize many other uses for such a count of relevant files and directories in a NTFS volume.

In one embodiment, an anti-pestware application uses such a count of relevant files and directories. The anti-pestware application scans all relevant files and directories in the volume for pestware, which may include malware, spyware, or any of a wide variety of other types of suspicious or undesirable programs. In this particular embodiment, a “relevant” file or directory is one that needs to be scanned for pestware in accordance with predetermined criteria. Some directories on a computer may contain files that can be ignored by the anti-pestware application or that should not be disturbed by such a program. Those directories and their associated files can be excluded from the count of relevant files and directories, as will be explained more fully below.

In other embodiments involving a computerized process other than an anti-pestware application, the criteria for what makes a file or directory “relevant” are tailored to the particular computerized process. In general, a file or directory that is “relevant” to a particular application is one that the particular application keeps track of, accesses, manipulates, or processes in some fashion.

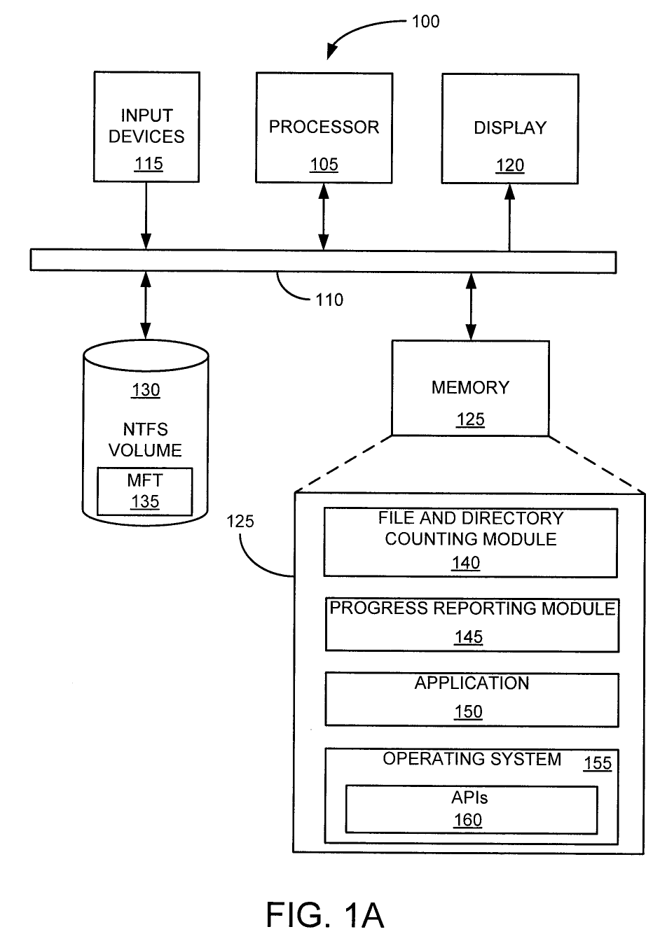

Referring now to the drawings, where like or similar elements are designated with identical reference numerals throughout the several views and referring in particular to FIG. 1A, it is a functional block diagram of a digital computer system 100 in accordance with an illustrative embodiment of the invention. Digital computer system 100 may be programmed to carry out the methods of the invention in accordance with various illustrative embodiments. Digital computer 100 may be a desktop computer, workstation, laptop computer, notebook computer, handheld computer, or any other device that includes computing functionality. In FIG. 1A, processor 105 communicates over data bus 110 with input devices 115, display 120, memory 125, and NTFS volume 130.

Input devices 115 may be, for example, a keyboard and a mouse or other pointing device. In one illustrative embodiment, NTFS volume 130 is a disk volume such as a hard disk drive (HDD). In other embodiments, however, NTFS volume 130 can be any type of rewritable NTFS volume, including, without limitation, magnetic disks, rewritable optical discs, and flash-memory-based storage media such as secure digital (SD) cards and multi-media cards (MMCs). Further, the methods of the invention may, in some embodiments, be implemented as program instructions stored on a computer-readable storage medium such as NTFS volume 130 or other suitable computer-readable storage medium. NTFS volume 130 includes Master File Table (MFT) 135. MFT 135 is a special file that contains metadata about every file and directory in NTFS volume 130.

Memory 125 may include random-access memory (RAM), read-only memory (ROM), flash memory, or a combination thereof. In the illustrative embodiment shown in FIG. 1A, memory 125 includes file and directory counting module 140, progress reporting module 145, an application 150, and operating system 155, which includes one or more application programming interfaces (APIs) 160.

File and directory counting module 140 is configured to count the files and directories contained in NTFS volume 130. In particular, file and directory counting module 140 is configured to count those files and directories in NTFS volume 130 that are relevant in some way to application 150. For example, in one embodiment, application 150 is an anti-pestware program that scans NTFS volume 130 for pestware and takes appropriate corrective action if pestware is found. In this embodiment, the relevant files and directories in NTFS volume 130 are those to be scanned for pestware. Of the totality of files and directories in NTFS volume 130, not all of the files and directories necessarily need to be scanned for pestware. For example, in some embodiments, files in directories such as “System Volume Information,” files or directories corresponding to the first 16 MFT entries (these contain special metadata), and any other portions of digital computer system 100 that do not need to be scanned for pestware (e.g., the Recycle Bin) are omitted from the pestware scan. In such embodiments, file and directory counting module 140 subtracts these excluded files and directories from the rapidly determined total number of files and directories in NTFS volume 130 to obtain the count of relevant files and directories.

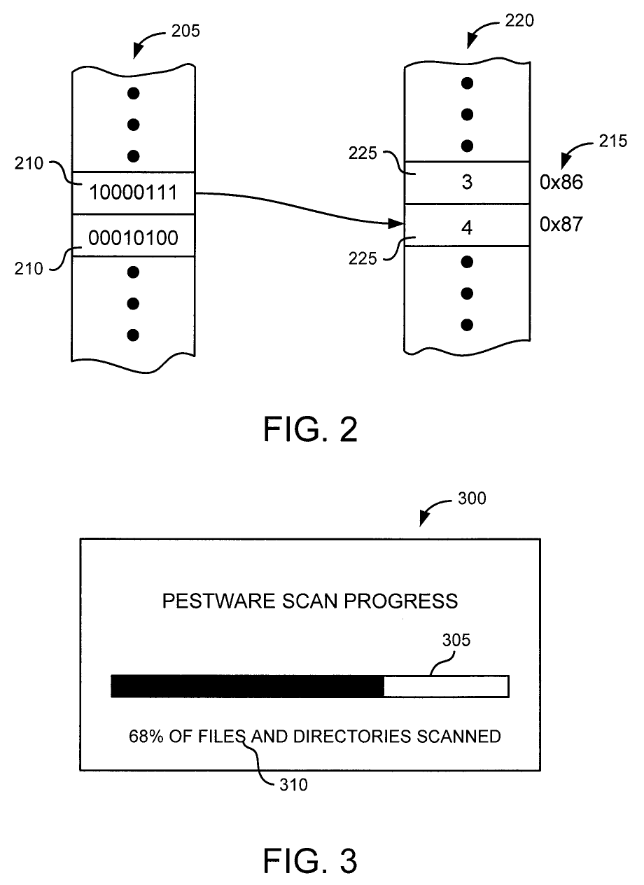

In the illustrative embodiment shown in FIG. 1A, progress reporting module 145 displays a progress indicator (e.g., a progress bar, a textual readout, or both) indicating, with the passage of time, what proportion of the files and directories in NTFS volume 130 has been processed by application 150. This progress indicator is based on the number of relevant files and directories computed by file and directory counting module 140. For example, if file and directory counting module 140 determines that there are 5,200 relevant files and directories in NTFS volume 130 and that 2600 files and directories have been processed so far (e.g., in a pestware scan), progress reporting module 145 would display a progress indicator indicating that 50 percent of the files and directories have been processed. As the proportion of processed files and directories increases, progress reporting module 145 updates the progress indicator accordingly. One simple example of a progress indicator is shown in FIG. 3. Progress reporting module 145 may be part of application 150, or it may be a function or subroutine that is separate from application 150 and called by application 150, depending on the particular embodiment.

In the illustrative embodiment shown in FIG. 1A, operating system 155 is any of a wide variety of WINDOWS operating systems from Microsoft Corporation. Examples include, without limitation, WINDOWS NT, WINDOWS 2000, WINDOWS XP, WINDOWS SERVER 2003, and WINDOWS VISTA. These operating systems support NTFS volumes, as those skilled in the art are aware.

FIG. 1B is a functional block diagram of a digital computer system 162 in accordance with another illustrative embodiment of the invention. In this embodiment, digital computer system 162 includes, in memory 125, memory management module 165. Memory management module 165 makes use of the count of relevant files and directories computed by file and directory counting module 140 in determining memory requirements for an application 170. For example, memory management module 165 may use the count of relevant files and directories in requesting memory for or allocating memory to application 170. Depending on the particular embodiment, memory management module 165 may be part of application 170 or separate from it. Application 170 may be the same application as application 150 in FIG. 1A or a different application, depending on the particular embodiment. In one particular embodiment, application 170 is an anti-pestware program similar to that described above.

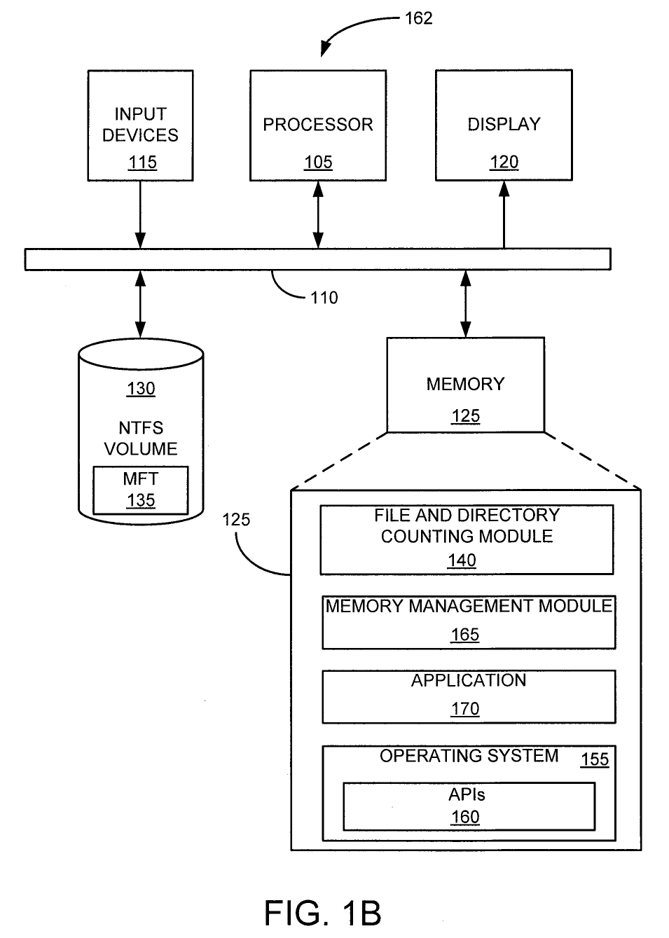

FIG. 2 is a diagram of a Master File Table (MFT) bitmap 205 and a lookup table 220 for rapidly counting files and directories in a NTFS volume in accordance with an illustrative embodiment of the invention. MFT bitmap 205 is a data structure associated with MFT 135 that is made up of a series of bytes 210 (eight-bit binary values). Each bit of each byte 210 of MFT bitmap 205 corresponds to a particular distinct MFT entry in MFT 135, each bit indicating the status—in use or unused—of its corresponding MFT entry. As those skilled in the art are aware, the MFT attribute for MFT bitmap 205 is 0xB0 of MFT entry 0.

In one embodiment, a bit equal to logic “1” indicates that the corresponding MFT entry is in use in association with either a file or a directory in NTFS volume 130. (In this embodiment, files and directories are counted together, so there is no need to determine whether a particular MFT entry corresponds to a file or a directory. In an embodiment in which the computerized process is an anti-pestware program, for example, NTFS directories themselves may contain detectable pestware indicators and thus need to be scanned along with the files they contain.) In this embodiment, a bit equal to logic “0” indicates that the corresponding MFT entry is unused (not yet associated with a file or directory). In normal use, MFT bitmap 205 enables digital computer system 100 (or 162) to find the first available MFT entry in MFT 135 to assign to a new file or directory by simply scanning MFT bitmap 205 for the first “0” bit. Those skilled in the art will recognize that the binary values “1” and “0” used to indicate whether a given bit corresponds to an MFT entry that is “in use” or “unused,” respectively, could be reversed in other embodiments, so long as consistency is maintained.

File and directory counting module 140 can rapidly determine the total number of files and directories in NTFS volume 130 by counting the number of bits in MFT bitmap 205 that correspond to used MFT entries (those associated with files and directories in NTFS volume 130). In the illustrative embodiment described above, this involves simply counting the “1's” in MFT bitmap 205.

FIG. 2 indicates one rapid, efficient way in which to count the bits in MFT bitmap 205 that correspond to used MFT entries (files and directories). In FIG. 2, an arbitrary byte 210 in MFT bitmap 205 is equal to “10000111.” File and directory counting module 140 uses this byte of MFT bitmap 205 as an a index 215 to access a corresponding entry 225 in lookup table 220. Lookup table 220 contains the number of bits corresponding to used MFT entries in each possible value of index 215. Those skilled in the art will recognize that there are 256 possible values that a byte 210 of MFT bitmap 205 can take on. Thus, lookup table 220, in this embodiment, includes 256 entries 225.

In the particular example shown in FIG. 2, byte 210 “10000111” contains four “1's.” Thus, the partial count (subtotal) of files and directories for this particular byte 210 (225) is four. When file and directory counting module 140 accesses lookup table 220 using byte 210 “10000111” as an index 215, this partial file and directory count (225) “4” is returned. Thus, only one access of lookup table 220 per byte 210 is required to count all of the bits in MFT bitmap 205 corresponding to used MFT entries. File and directory counting module 140 sums the partial files and directory counts 225 for the bytes 210 of MFT bitmap 205 to obtain the total number of files and directories in NTFS volume 130. In FIG. 2, the index value 215 corresponding to byte 210 “10000111” is shown as the hexadecimal value “0x87.” The other byte 210 “00010100” and index 215 “0x86” hex are included in FIG. 2 merely for purposes of illustration.

The above lookup-table-based approach to counting bits in MFT bitmap 205 that correspond to used MFT entries is merely one possible implementation. In other embodiments, the bits of a given byte 210 of MFT bitmap 205 are individually tested, and the bits corresponding to used MFT entries are counted. For example, a byte 210 may be bit tested and shifted by one bit repeatedly until each bit the in the byte 210 has been considered. Those skilled in the art will recognize that there are still other methods for counting bits in the MFT bitmap 205 that correspond to used MFT entries, all of which are within the scope of the claims.

To exclude particular files and directories from the count of relevant files and directories, file and directory counting module 140 can be configured to use APIs 160 such as “FindFirst” and “FindNext” of operating system 155 to identify and count such files and directories. For example, in one embodiment an anti-pestware application does not scan files in the WINDOWS system directory “System Volume Information.” Directory counting module 140, in this embodiment, calls “FindFirst” to locate the first file in the selected directory. By calling “FindNext” repeatedly until operating system 155 reports that no further files exist in that directory, file and directory counting module 140 can ascertain the number of files in “System Volume Information.”

This procedure can be repeated for additional directories in NTFS volume 130 that are to be excluded from the count of files and directories that are relevant to application 150 or 170. The count of files and directories deemed not to be relevant to the computerized process can then be subtracted from the rapidly obtained total number of files and directories obtained via MFT bitmap 205 to yield the number of files and directories that are relevant to the computerized process.

In many applications, the number of files to be excluded (and thus counted one at a time using APIs 160 as described above) is a relatively small percentage of the total. As a result, the combination of rapidly counting the total files and directories in NTFS volume 130 using MFT bitmap 205 and subtracting a small subset of files and directories counted using APIs 160 provides a significant overall speed improvement. These techniques allow, for example, a progress indicator for a pestware scan to be displayed after a few seconds instead of after a delay of over two minutes, for example.

In one embodiment, the bits of MFT bitmap 205 corresponding to the first 16 entries of MFT 135 are also excluded from the count of relevant files and directories. File and directory counting module 140 can be configured, for example, to automatically subtract 16 from the total count of files and directories in NTFS volume 130 obtained via MFT bitmap 205. In other embodiments, file and directory counting module 140 can be configured to skip the first two bytes 210 of MFT bitmap 205 or otherwise not to count the bits corresponding to used MFT entries in those first two bytes of MFT bitmap 205.

In some embodiments, still other files and/or directories are excluded and, therefore, counted and subtracted from the total number of files and directories obtained through use of MFT bitmap 205. For example, the WINDOWS Recycle Bin may not be considered a relevant directory in some applications.

FIG. 3 is an illustration of a progress indicator 300 in accordance with an illustrative embodiment of the invention. Progress indicator 300 includes a progress bar 305 that indicates, with the passage of time, what proportion of the relevant files and directories an anti-pestware application has scanned for pestware. Optionally, progress indicator 300 may also include text 310 that includes a numerical percentage, as shown in FIG. 3. In some embodiments, the number of files and directories that are relevant to the computerized process, as determined by file and directory counting module 140, is also displayed to a user (e.g., “1666 files and directories of 2450 scanned”).

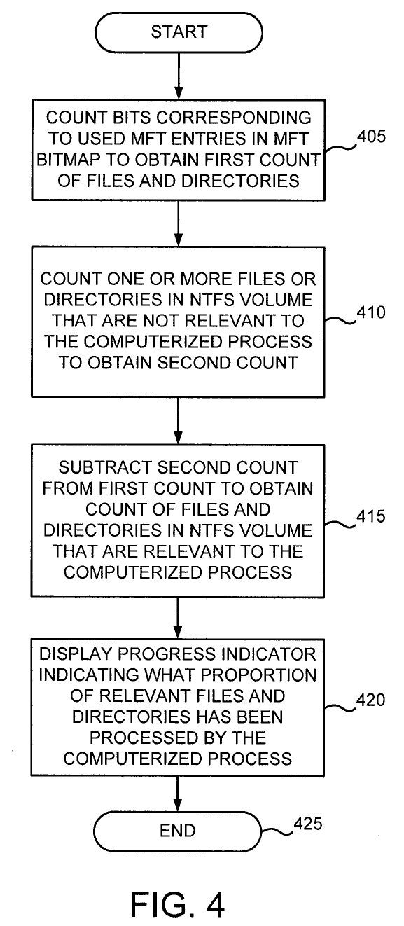

FIG. 4 is a flowchart of a method for counting files and directories in a NTFS volume 130 that are relevant to a computerized process in accordance with an illustrative embodiment of the invention. At 405, file and directory counting module 140 counts bits corresponding to used MFT entries in MFT bitmap 205 to obtain a first count of files and directories in NTFS volume 130. In counting these bits, file and directory counting module 140 may employ a lookup table such as lookup table 220 shown in FIG. 2 to further speed up the counting process.

In some embodiments, the first count represents the total of all files and directories in NTFS volume 130 (that is, all bits in MFT bitmap 205 are considered in the counting process). In other embodiments, most but not necessarily all of the bits in MFT bitmap 205 are considered in the counting process. For example, the first two bytes of MFT bitmap 205 may be skipped, or the bits of those first two bytes that correspond to used MFT entries may be otherwise omitted from the count to exclude from the tally the bits associated with the first 16 MFT entries, as explained above.

At 410, file and directory counting module 140 counts one or more files or directories in NTFS volume 130 that are not relevant to the computerized process to obtain a second count. In one illustrative embodiment, file and directory counting module 140 obtains the second count by using one or more APIs 160 such as “FindFirst” and “FindNext” to count the files in one or more specific directories to be excluded. At 415, file and directory counting module 140 subtracts the second count from the first count to obtain a count of the files and directories in NTFS volume 130 that are relevant to a predetermined computerized process (e.g., application 150 or 170).

At 420, progress reporting module 145 displays a progress indicator (see, e.g., FIG. 3) indicating, with the passage of time, what proportion of the relevant files and directories computed at 415 has been processed by the computerized process. At 425, the method terminates.

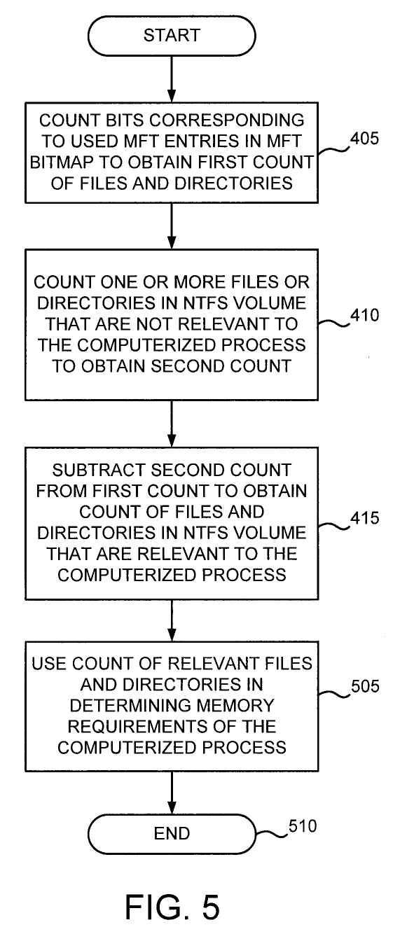

FIG. 5 is a flowchart of a method for counting files and directories in a NTFS volume 130 that are relevant to a computerized process in accordance with another illustrative embodiment of the invention. The method proceeds as in FIG. 4 through Block 415. At 505, memory management module 165 uses the count obtained at 415 of files and directories that are relevant to the computerized process to determine memory requirements of the computerized process, as discussed above. At 510, the method terminates.

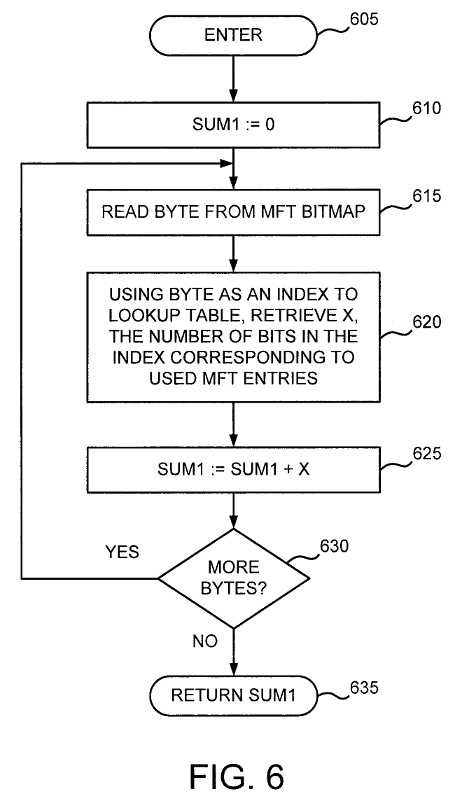

FIG. 6 is a flowchart of a method for rapidly counting substantially all of the files and directories in a NTFS volume in accordance with an illustrative embodiment of the invention. The method is entered at 605. At 610, file and directory counting module 140 initializes a variable “SUMI” to zero. At 615, file and directory counting module 140 reads a byte 210 from MFT bitmap 205. At 620, using byte 210 as an index 215 to a lookup table 220, file and directory counting module 140 retrieves X, the number of bits in index 215 that correspond to used MFT entries. The quantity X is thus a partial count (see 225 in FIG. 2) of files and directories for the byte 210 read at 615.

At 625, file and directory counting module 140 adds X to SUMI, the running total of files and directories in NTFS volume 130, and saves the result in SUMI. If there are no more bytes 210 to be processed at 630, the method returns SUMI at 635. Otherwise, the method returns to 615 to process the next byte of MFT bitmap 205.

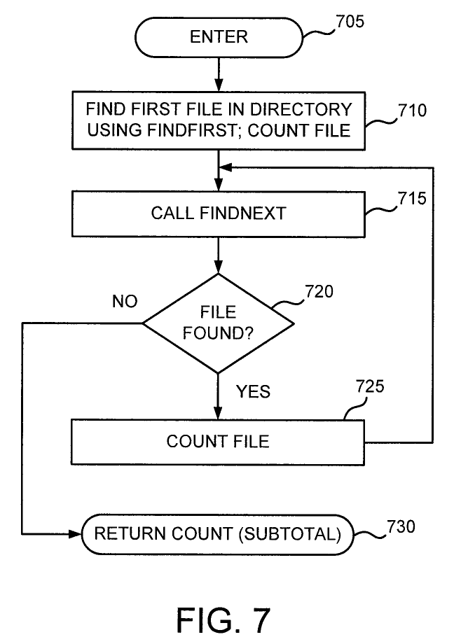

FIG. 7 is a flowchart of a method for counting files that are not relevant to a computerized process in accordance with another illustrative embodiment of the invention. The method is entered at 705. At 710, file and directory counting module 140 finds, using an API 160 such as FindFirst, the first file in a chosen directory (e.g., “System Volume Information”) that, along with the files it contains, is to be excluded from the count of relevant files and directories. This first file is counted. At 715, file and directory counting module 140 calls an API 160 such as FindNext. If an additional file is found at 720, file and directory counting module 140 adds that file to the count at 725.

The loop consisting of Blocks 715, 720, and 725 is repeated until operating system 155 indicates that the chosen directory contains no more files. The final count for the given directory (the directory itself and the number of files found within it) is returned at 730. The method shown in FIG. 7 can be repeated for each directory to be excluded from the count of files and directories that are relevant to the computerized process. The subtotals for the directories to be excluded are then totaled to obtain the “second count” in Block 410 of FIGS. 4 and 5. As explained above, other components (e.g., the MFT-bitmap bits associated with the first 16 MFT entries or the Recycle Bin) may also be part of the count of files and directories that are not relevant to the computerized process, depending on the particular embodiment.

It should be noted that the count of relevant files and directories obtained need not be precise in every embodiment. In many applications, accuracy within a few percentage points is sufficient, especially when the count of relevant files and directories is to be used in connection with a progress indicator.

In conclusion, the present invention provides, among other things, a method and system for counting files and directories in a NTFS volume that are relevant to a computerized process. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A method for counting files and directories in a New-Technology-File-System (NTFS) volume that are relevant to a computerized process, the method comprising:
counting bits corresponding to used MFT entries in a Master File Table (MFT) bitmap associated with the NTFS volume to obtain a first count, each used MFT entry corresponding to one of a file and a directory in the NTFS volume;
counting one or more files or directories in the NTFS volume that are not relevant to the computerized process to obtain a second count;
subtracting the second count from the first count to obtain a count of files and directories in the NTFS volume that are relevant to the computerized process; and
displaying a progress indicator that indicates, with the passage of time, what proportion of the files and directories included in the count of files and directories in the NTFS volume that are relevant to the computerized process has been processed by the computerized process.

2. The method of claim 1, wherein the computerized process includes a scan of the NTFS volume for pestware.

3. The method of claim 1, wherein counting bits corresponding to used MFT entries in a MFT bitmap associated with the NTFS volume to obtain a first count includes:
using each byte of the MFT bitmap as an index to a lookup table containing, for each possible value of the index, the number of bits in the index that correspond to used MFT entries to obtain a partial file and directory count for that byte of the MFT bitmap; and
summing the partial file and directory counts to obtain the first count.

4. The method of claim 1, wherein counting one or more files or directories in the NTFS volume that are not relevant to the computerized process to obtain a second count includes:
finding a first file in a particular directory using a FindFirst application programming interface (API) of an operating system of a computer; and
finding at least one other file in the particular directory using a FindNext API of the operating system.

5. The method of claim 1, wherein the count of files and directories in the NTFS volume that are relevant to the computerized process is displayed as a number.

6. A method for counting files and directories in a New-Technology-File-System (NTFS) volume that are relevant to a computerized process, the method comprising:
counting bits corresponding to used MFT entries in a Master File Table (MFT) bitmap associated with the NTFS volume to obtain a first count, each used MFT entry corresponding to one of a file and a directory in the NTFS volume;
counting one or more files or directories in the NTFS volume that are not relevant to the computerized process to obtain a second count;
subtracting the second count from the first count to obtain a count of files and directories in the NTFS volume that are relevant to the computerized process; and
using the count of files and directories in the NTFS volume that are relevant to the computerized process in determining memory requirements for the computerized process.

7. The method of claim 6, wherein the computerized process includes a scan of the NTFS volume for pestware.

8. The method of claim 6, wherein counting bits corresponding to used MFT entries in a MFT bitmap associated with the NTFS volume to obtain a first count includes:
using each byte of the MFT bitmap as an index to a lookup table containing, for each possible value of the index, the number of bits in the index that correspond to used MFT entries to obtain a partial file and directory count for that byte of the MFT bitmap; and
summing the partial file and directory counts to obtain the first count.

9. The method of claim 6, wherein counting one or more files or directories in the NTFS volume that are not relevant to the computerized process to obtain a second count includes:
finding a first file in a particular directory using a FindFirst application programming interface (API) of an operating system of a computer; and
finding at least one other file in the particular directory using a FindNext API of the operating system.

10. The method of claim 6, wherein the count of files and directories in the NTFS volume that are relevant to the computerized process is displayed as a number.

11. A digital computer system programmed to perform the following method:
counting bits corresponding to used MFT entries in a Master File Table (MFT) bitmap associated with a New-Technology-File-System (NTFS) volume to obtain a first count, each used MFT entry corresponding to one of a file and a directory in the NTFS volume;
counting one or more files or directories in the NTFS volume that are not relevant to the computerized process to obtain a second count;
subtracting the second count from the first count to obtain a count of files and directories in the NTFS volume that are relevant to the computerized process; and
displaying a progress indicator that indicates, with the passage of time, what proportion of the files and directories included in the count of files and directories in the NTFS volume that are relevant to the computerized process has been processed by the computerized process

12. The digital computer system of claim 11, wherein the computerized process includes a scan of the NTFS volume for pestware.

13. The digital computer system of claim 11, wherein counting bits corresponding to used MFT entries in a MFT bitmap associated with the NTFS volume to obtain a first count includes:
using each byte of the MFT bitmap as an index to a lookup table containing, for each possible value of the index, the number of bits in the index that correspond to used MFT entries to obtain a partial file and directory count for that byte of the MFT bitmap; and
summing the partial file and directory counts to obtain the first count.

14. The digital computer system of claim 11, wherein counting one or more files or directories in the NTFS volume that are not relevant to the computerized process to obtain a second count includes:
finding a first file in a particular directory using a FindFirst application programming interface (API) of an operating system of the digital computer system; and
finding at least one other file in the particular directory using a FindNext API of the operating system.

15. The digital computer system of claim 11, wherein the count of files and directories in the NTFS volume that are relevant to the computerized process is displayed as a number.

16. A digital computer system programmed to perform the following method:
counting bits corresponding to used MFT entries in a Master File Table (MFT) bitmap associated with a New-Technology-File-System (NTFS) volume to obtain a first count, each used MFT entry corresponding to one of a file and a directory in the NTFS volume;
counting one or more files or directories in the NTFS volume that are not relevant to the computerized process to obtain a second count;
subtracting the second count from the first count to obtain a count of files and directories in the NTFS volume that are relevant to the computerized process; and
using the count of files and directories in the NTFS volume that are relevant to the computerized process in determining memory requirements for the computerized process.

17. The digital computer system of claim 16, wherein the computerized process includes a scan of the NTFS volume for pestware.

18. The digital computer system of claim 16, wherein counting bits corresponding to used MFT entries in a MFT bitmap associated with the NTFS volume to obtain a first count includes:
using each byte of the MFT bitmap as an index to a lookup table containing, for each possible value of the index, the number of bits in the index that correspond to used MFT entries to obtain a partial file and directory count for that byte of the MFT bitmap; and
summing the partial file and directory counts to obtain the first count.

19. The digital computer system of claim 16, wherein counting one or more files or directories in the NTFS volume that are not relevant to the computerized process to obtain a second count includes:
finding a first file in a particular directory using a FindFirst application programming interface (API) of an operating system of the digital computer system; and
finding at least one other file in the particular directory using a FindNext API of the operating system.

20. The digital computer system of claim 16, wherein the count of files and directories in the NTFS volume that are relevant to the computerized process is displayed as a number.

21. A computer-readable storage medium containing program instructions implementing the method of claim 1.

22. A computer-readable storage medium containing program instructions implementing the method of claim 6.
